(19) United States
(12) Patent Application Publication
(10) Pub. No.: US 2024/0353802 A1
(43) Pub. Date: Oct. 24, 2024

(54) TOUCHLESS MULTI-STAGED RETAIL PROCESS AUTOMATION SYSTEMS AND METHODS

(71) Applicant: T-Mobile USA, Inc., Bellevue, WA (US)

(72) Inventors: Jacob Holman, Bonney Lake, WA (US); Ravikiran Mahadevappa Sindogi, Bothell, WA (US); Michael Lim Tang, Bellevue, WA (US)

(21) Appl. No.: 18/676,094

(22) Filed: May 28, 2024

Related U.S. Application Data
(63) Continuation of application No. 17/329,002, filed on May 24, 2021, now Pat. No. 12,019,410.

(51) Int. Cl. G05B 11/01; G06N 20/00; G06Q 10/10; G06Q 30/0201

(52) U.S. Cl. CPC G05B 11/01; G06N 20/00; G06Q 10/10; G06Q 30/0201

(57) ABSTRACT

A touchless multi-staged retail process automation systems and methods (retail process automation system) to automate key store functionalities within retail stores is disclosed. The retail process automation system receives a set of commands (e.g., a voice command) to automatically perform retail store operations such as opening a store, closing a close, automatically opening tills, etc. with the single command. As a result, the retail process automation system replaces the multiple-touches required by conventional systems with a touchless solution, thereby providing increased time and resource efficiency of managing store operations. For example, the retail process automation system intercepts a voice command to identify the associated retail store information and source of the command. The retail process automation system then generates a set of operations associated with the received voice command to alter a state of the retail store.

### CROSS-REFERENCE TO RELATED APPLICATIONS

This application is a continuation of U.S. patent application Ser. No. 17/329,002, filed May 24, 2021, which is hereby incorporated by reference in its entirety.

### BRIEF DESCRIPTION OF THE DRAWINGS

FIG. 1 is a system diagram illustrating an example of a computing environment in which the retail process automation system operates according to various implementations.

FIG. 2 is a flow diagram illustrating a process of retail process automation system according to various implementations.

FIG. 3 is a flow diagram illustrating a process of retail process automation according to various implementations.

FIG. 4 is a data flow diagram showing a typical process used by the retail process automation system in some embodiments to generate suggested modifications corresponding to an instruction trigger.

FIGS. 5A-5H are examples of user interfaces that can be used according to various implementations.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Retailers typically maintain hundreds, if not thousands of stores. Each store is unique and offers a set of services and products to customers. Store operations are complex and comprise several steps for both store opening and store closing. For instance, in a retail store environment, a worker (e.g., a cashier) will start his/her shift with a starting till when a store opens. This is an amount of money made up of a certain amount of notes of varying denominations and a certain amount of coin. Different store tills can be associated with different starting amounts. The tills can be associated with a central system such that a store can be activated/opened after the tills are brought online with a centralized system. In addition, one or more reports (e.g., tills summary report) can be generated when a store opens. Similarly, when a store closes, the open tills are closed, their ending amount is captured, and one or more end-of-day reports are run. Typically, a store manager performs a set of detailed steps to open or close a store. Moreover, a store manager has to perform the multi-touch steps in a specific order. However, depending on certain criteria (e.g., weekend, holiday week, light day, busy day, etc.), the store manager may perform different steps and/or steps in a different order to open the same store. Also, different users may open the same store with different profiles. For example, while a store manager may open a store with five tills, a regional manager may be authorized to open the same store with fifteen tills with varying opening accounts, and different reports. Overall, store opening and closing can take anywhere from 20 minutes to an hour—and even then, the possibility of human/manual error is high. Since store opening and closing operations are complex and involve multiple touch-points (e.g., managing multiple tills and associated starting and ending amounts, report generation infrastructure, and so on), these operations are time and resource intensive.

To solve these and other problems with conventional systems, the inventors have conceived and reduced to practice touchless multi-staged retail process automation systems and methods (retail process automation system) to automate key store functionalities within retail stores. The retail process automation system receives a single command (e.g., a voice command) to automatically perform retail store operations such as opening a store, closing a store, automatically opening tills, etc. with the single command. As a result, the retail process automation system replaces the multiple-touches required by conventional systems with a touchless solution, thereby providing increased time and resource efficiency of managing store operations. For example, the retail process automation system intercepts a voice command (e.g., “Open store ABC in regular mode”) to identify the associated retail store information (e.g., store identifier) and source of the command (e.g., user who invoked the command). The retail process automation system then generates a set of operations associated with the received voice command. For example, the retail process automation system generates a set of API calls for opening a store when it receives a voice command “Open store ABC in regular mode.” The retail process automation system can then intercept the responses from the APIs and continue down a particular operational flow, all with a single command.

In the following description, for the purposes of explanation, numerous specific details are set forth in order to provide a thorough understanding of implementations of the present technology. It will be apparent, however, to one skilled in the art, that implementations of the present technology can be practiced without some of these specific details.

The phrases “in some implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

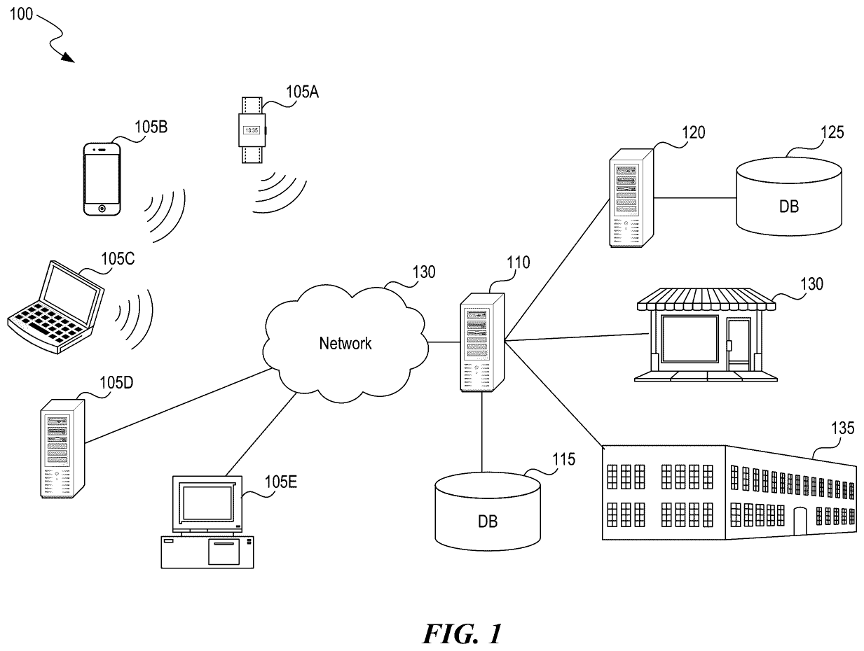

FIG. 1 is a system diagram illustrating an example of a computing environment in which the retail process automation system operates according to various implementations. In some implementations, environment 100 includes one or more client computing devices 105A-E, examples of which can include computer system 600. Client computing devices 105 operate in a networked environment using logical connections through network 130 to one or more remote computers, such as a server computing device. Client computing devices 105 can receive commands/instructions from one or more users to perform retail store operations.

In some implementations, server 110 is an edge server which receives client requests. Server 110 can coordinate fulfillment of those requests through other servers, such as server 120. Server 110 can route those requests to computing devices located in one or more identified retail stores, such as stand-alone store 140, store in a group location, such as a mall 135, and so on. Server computing devices 110 and 120 comprise computing systems, such as computer system 600. Though each server computing device 110 and 120 is displayed logically as a single server, server computing devices can each be a distributed computing environment encompassing multiple computing devices located at the same or at geographically disparate physical locations. In some implementations, each server 120 corresponds to a group of servers.

Client computing devices 105 and server computing devices 110 and 120 can each act as a server or client to other server/client devices. In some implementations, servers (110, 120) connect to a corresponding database (115, 125). As discussed above, each server 120 can correspond to a group of servers, and each of these servers can share a database or can have its own database. Databases 115 and 125 warehouse (e.g., store) information such as store information (e.g., store identifier, location, capacity, number of tills, type of store, etc.), store employee information (e.g., number of employees, manager identifier(s), employee identifier(s), employee name(s), addresses, contact details, etc.), operations information (e.g., operation flows, operation dependencies, operations history, etc.), and so on. Though databases 115 and 125 are displayed logically as single units, databases 115 and 125 can each be a distributed computing environment encompassing multiple computing devices, can be located within their corresponding server, or can be located at the same or at geographically disparate physical locations.

Network 130 can be a local area network (LAN) or a wide area network (WAN), but can also be other wired or wireless networks. In some implementations, network 130 is the Internet or some other public or private network. Client computing devices 105 are connected to network 130 through a network interface, such as by wired or wireless communication. While the connections between server 110 and servers 120, and stores 140, 135 are shown as separate connections, these connections can be any kind of local, wide area, wired, or wireless network, including network 130 or a separate public or private network.

Aspects of the system can be implemented in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). Portions of the system can reside on a server computer, while corresponding portions can reside on a client computer such as a mobile or portable device, and thus, while certain hardware platforms are described herein, aspects of the system are equally applicable to nodes on a network. In alternative implementations, the mobile device or portable device can represent the server portion, while the server can represent the client portion.

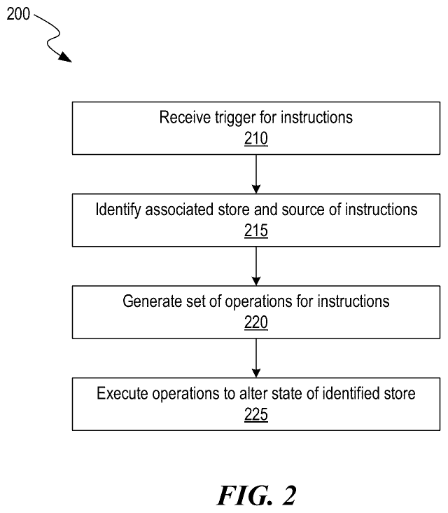

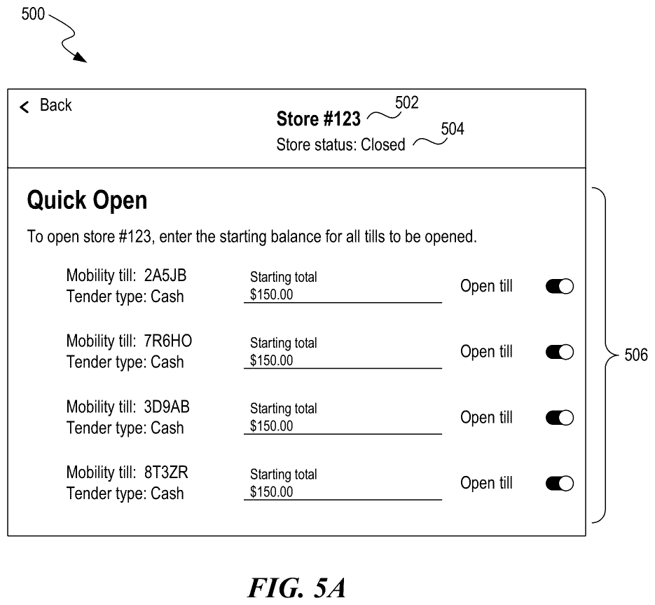

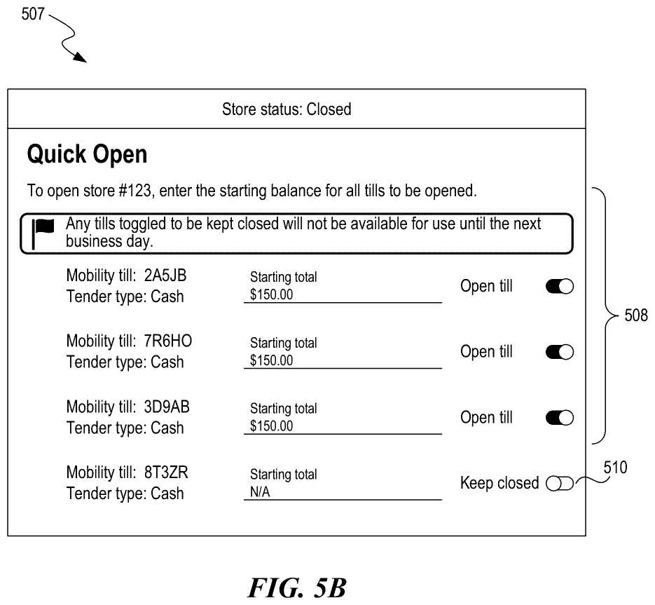

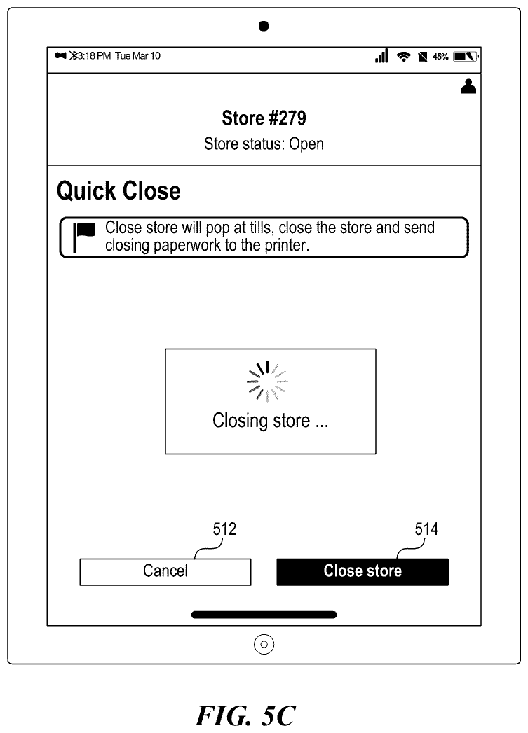

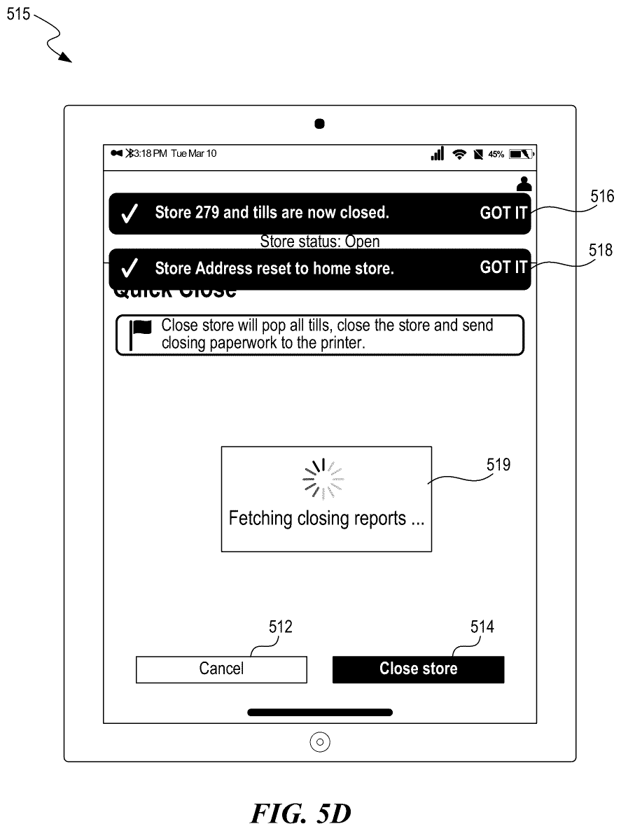

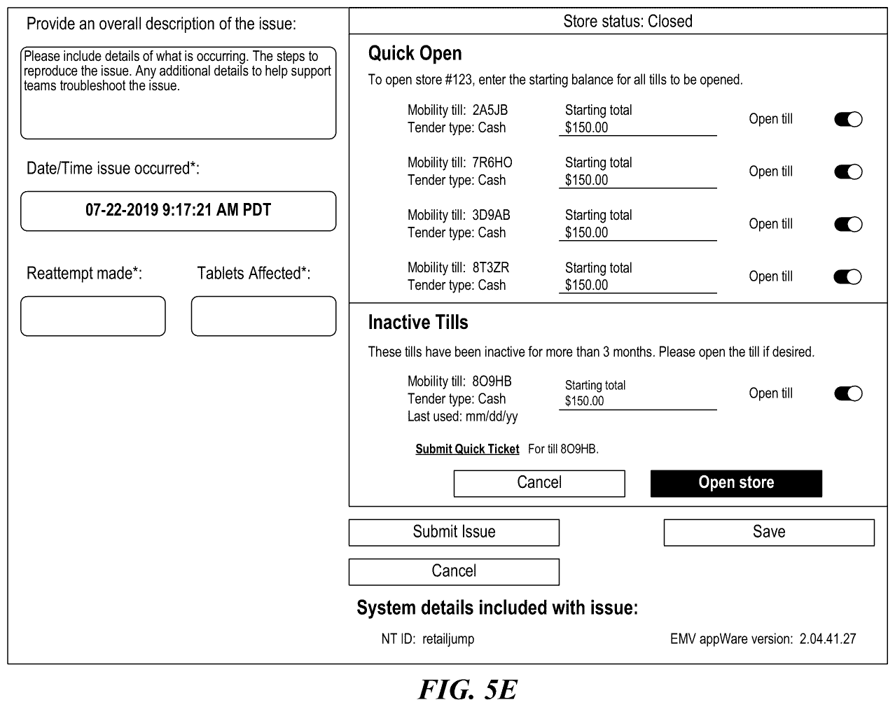

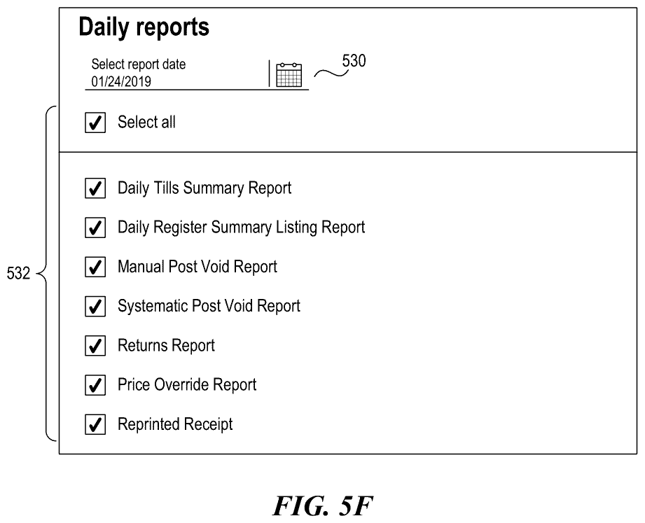

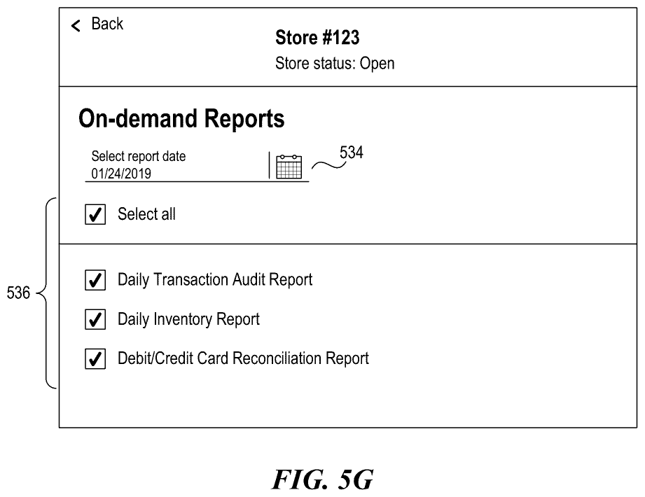

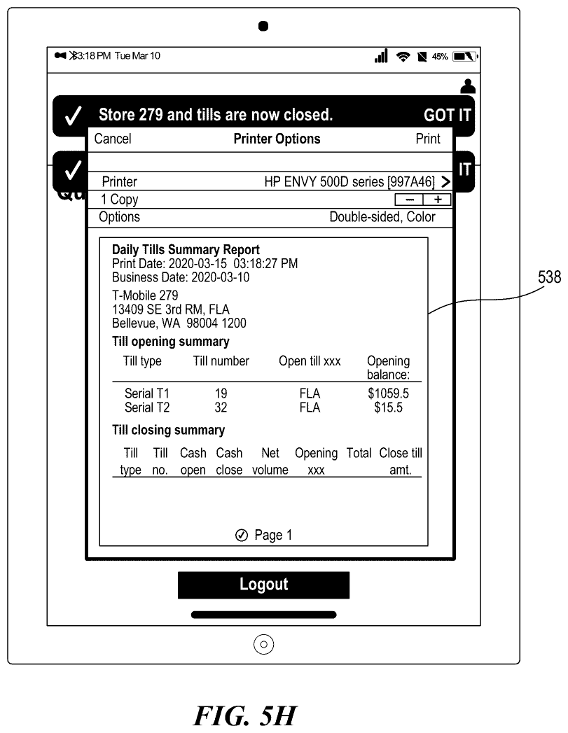

FIG. 2 is a flow diagram illustrating a process 200 of retail process automation according to various implementations. Process 200 begins at act 210 where it receives a trigger for instructions related to a retail store. The trigger can be in the form of voice command(s), UI command(s), and so on. For example, the trigger for instructions can be received via a voice bot application, such as Siri®, Alexa®, and so on. The instructions trigger can be associated with an intent, such as opening a store, closing a store, running reports, and so on. For example, as illustrated in FIG. 5A, process 200 can receive instructions (via a voice command and/or a user interface) to “Quick open store ABC with all tills at $150.” As another example, as illustrated in FIG. 5B, process 200 can receive instructions via a UI selection to “Open first three tills of store ABC with $150.” Other examples of instructions include, but are not limited to searching for customer information (e.g., “Search customer “1234567890”), activate an account (e.g., “Start activation”), modify customer account (e.g., “Start adding new line”), manage payments (e.g., “Take payment” within a flow), add reports, automating number of tolls to be opened based on number of scheduled workers for a day, and so on. Process 200 enables users to customize or set preference commands, which can be loaded by authentication module. In some implementations, process 200 receives a set of instructions. For example, process 200 can receive the following set of instructions to open a store: “Open first three tills of store ABC with $150; Run reports 2, 3, and 4; Print reports at printer ABC.” In some implementations, process 200 receives instructions associated with one or more preconfigured profiles, such as normal day, rush day, weekend, holiday week, light day, busy day, etc. For example, process 200 receives the following instructions to open a store: “Open store as a weekend day.”

Upon receiving the instructions trigger, process 200, at act 215, identifies the store associated with the instructions. For example, upon receiving voice instructions to “Quick open store ABC with all tills at $150,” process 200 parses the instructions (using, for example, natural language processing methods) to identify that the store associated with the instructions trigger is “store ABC.” Process 200 can then access a data structure and/or a database to identify a store identifier associated with “store ABC.” In some implementations, process 200 can access a location of a user's device (via which the instructions trigger is received) to identify (or suggest) a store associated with the instructions. Process 200 can also identify a source of the voice instructions. For example, using a voice signature (and/or other biometrics information), process 200 can identify the source who initiated the instructions trigger. As other examples, process 200 can identify the source based on login information of a user, information of a user associated with the device from which the instructions trigger was received, and so on. In some implementations, process 200 can first identify the source of the instructions and then identify the associated store based on the source's past behavior (e.g., the last store managed by a store manager who triggered the current instructions).

In some implementations, when process 200 receives the trigger instructions, it can display the relevant information related to the trigger instructions at a user interface. FIG. 5A is an example user interface 500 displayed when process 200 receives a command to open a store with all tills at a default starting amount. User interface 500 displays store information 502, current store status 504, and till information 506. FIG. 5B is an example user interface 507 displayed when process 200 receives a command to open a store with some tills at a default starting amount. User interface 507 displays store open till information 508, and closed till information 510, with an option for the user to open the closed till(s) and specify an opening till amount. FIG. 5C is an example user interface displayed when process 200 receives a command to close a store; the user can be presented with options to cancel the store closing command using control 512 and/or confirm the store closing using control 514. FIG. 5E is an example user interface to help in opening issue ticket within a store. FIGS. 5F-5G are example user interfaces to help in generating reports, such as daily reports and/or on-demand reports. Users can select a report date using controls 530, 534, and select one or more reports to be generated using controls 532, 536.

At act 220, process 200 generates a set of operations for the received trigger instructions. Process 200 can select and/or compile the set of operations using the received trigger instructions. For example, after receiving a trigger instruction, process 200 can identify one or more instruction identifiers for the received trigger instruction (e.g., each type of trigger instruction can be associated with a unique identifier). As another example, when process 200 receives instructions associated with one or more preconfigured profiles, process 200 identifies the associated instruction identifiers associated with the selected profile. Then, based on the instruction identifier, process 200 can identify a set of operations associated with that instruction identifier. For example, for a trigger instruction to open a store, process 200 can identify the following set of operations: login, open cash drawers (till number, till starting amount), and activate store (brings tills online within all systems). As another example, for a trigger instruction to close a store, process 200 can identify the following set of operations: login, close cash drawers, and deactivate store (brings store offline within all systems). As another example, for a trigger instruction to generate reports for a store, process 200 can identify the following set of operations: tabulate transactions, generate report(s), and print report(s). As another example, for a trigger instruction to perform an audit of a store (e.g., “audit store ABC”), process 200 can automate the memos that are created for audits by gathering necessary data to maintain and update audit reports for the store.

Process 200 can then identify one or more APIs to invoke for the identified set of operations. For example, process 200 identifies the following APIs for opening a store: login API (user identifier), open cash drawer API (starting amount, till number, open command), and activate store API. As another example, process 200 identifies the following APIs for closing a store: login API (user identifier), close cash drawer API (ending amount, till number, close command), and deactivate store API. As another example, process 200 identifies the following APIs for generating reports for a store at periodic internals (e.g., end of day, audits, and so on): tabulate all transactions-balance APIs (starting amount, transactions, end amount), generate report API (can turn transaction information into a printable format (e.g., pdf), and print API (prints report(s) automatically)).

At act 225, process 200 executes the operations in the generated set of operations to alter the current state of the identified store. In some implementations, process 200 can auto advance a store operations management application through various views that illustrate the execution of the operations without any further user interaction. For example, process 200 can automatically execute the APIs associated with the set of operations to alter the current state of the identified store. FIG. 5D is an example user interface 515 displayed as process 200 executes operations to close a store. User interface 515 displays the operations and their statuses 516-519 as the operations are executed. FIG. 5H is an example user interface to enable a user to print a status report (using control 538) once process 200 completes execution of the operations. In some implementations, process 200 can execute the operations to alter the current state of the identified target retail store at an execution time later than a receipt time of the trigger for instructions. The execution time can be received as part of the trigger for instructions, can be determined based on past behavior of the source of the trigger instructions, can be determined based on one or more of the following: operating hours of the target retail store, or current events information, or the associated intent, and so on.

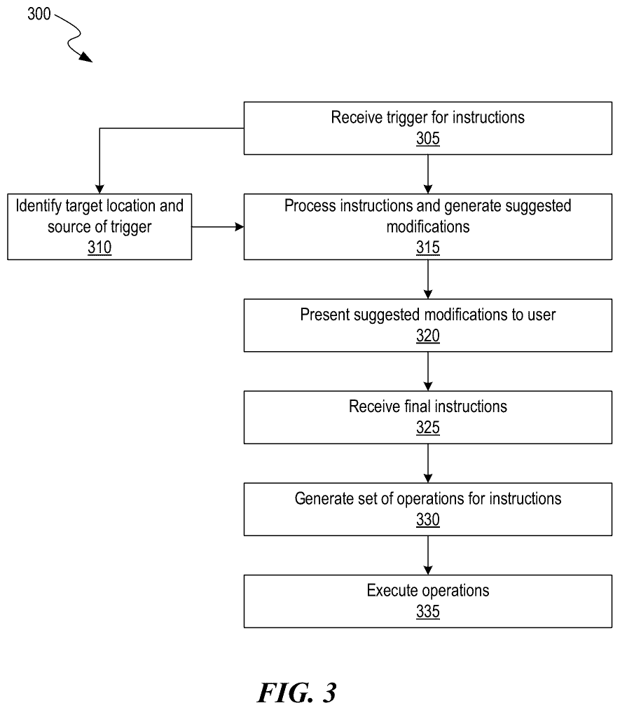

FIG. 3 is a flow diagram illustrating a process 300 of retail process automation according to various implementations. Similar to process 200 of FIG. 2, process 300 begins at act 305 where it receives a trigger for instructions related to a retail store. Upon receiving the instructions trigger, process 300, at act 310, identifies the store associated with the instructions and/or a source of the instructions (similar to act 215 of process 200). At act 315, process 300 processes the trigger instructions to generate one or more suggested modifications using, for example, one or more trained machine learning models.

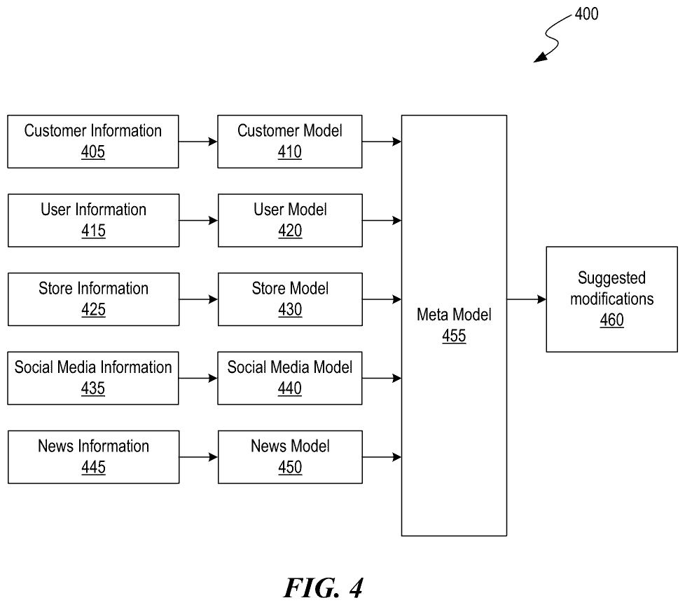

FIG. 4 is a data flow diagram showing a typical process used by the retail process automation system in some embodiments to generate suggested modifications corresponding to an instruction trigger. A customer information store 405 is shown, from which attributes of a customer are provided to a customer model 410 that produce customer behavior parameter values. The customer information store 405 can comprise information such as call service records, customer behavior information (e.g., time/day when customers access stores, how much time customers spend at a store, services/products utilized by customers, customer demographic information, customer age, customer employment information, customer education information, and so on). Examples of customer behavior parameters include, but are not limited to, popular times when customers visit store, customer behavior patterns, and so on. A user information store 415 is shown, from which attributes of a user are provided to a user model 420 that produce user behavior parameter values. The user information store 415 can comprise information such as user behavior information (e.g., time/day when users issue instructions, stores visited, types of instructions issued, form of instructions (e.g., verbal, UI, and so on), composition of instructions (e.g., single instructions with details, composite instructions with details, and so on), how much time users spend at a store, services/products utilized by users, users demographic information, users age, users employment information, users education information, and so on). Examples of user behavior parameters include, but are not limited to, typical times when user visit store, typical instructions issued by user, typical instructions issued by user of certain type (e.g., manager, cashier, service technician, etc.), user behavior patterns, and so on.

A store information store 425 is shown, from which attributes of a store are provided to a store model 430 that produce store parameter values. The store information store 425 can comprise information such as store location, operating hours, type (standalone, mall, etc.), stock information, till information, employee information, services/products offered, occupancy limits, and so on. Examples of store parameters include, but are not limited to, store occupancy behavior patterns, busy times, busy days, most popular services, most popular products, and so on. A social information store 435 is shown, from which attributes of social media presence are provided to a social media model 440 that produce social media behavior parameter values. The social information store 435 can comprise information about one or more social media accounts and/or aggregate information, such as post locations, post platform (e.g., Twitter®, Facebook®, Instagram®, Tinder®, TikTok®, etc.), post details, post date/time, and so on. Examples of social media behavior parameters include, but are not limited to, popular post dates/times, location of posts in reference to store location, and so on. A news information store 445 is shown, from which attributes of news events are provided to a news model 450 that produce news behavior parameter values. The news information store 445 can comprise information such as current events (e.g., launch of new product/service), disaster information, and so on. Examples of news behavior parameters include, but are not limited to, correlation between news events and customer behavior, correlation between news events and store occupancy/traffic, and so on. The outputs from one or more models are provided to a meta model 455. The meta model 455 applies various techniques such as input weighting, bias correction, data smoothing, and confidence interval estimation in producing one or more suggested modifications 460 to the received instructions.

In some implementations, when the retail process automation system receives a new command (for example, a command for which a corresponding set of operations is not available), the system can parse the new command to identify its constituent parts (e.g., parse a sentence to identify the constituent words). The system can then identify other previously stored and mapped command to identify matches for the new command (e.g., via k-means clustering and other similar techniques). In some implementations, when a new command is encountered, the system can prompt the user to map the new command to a set of operations. For example, upon receiving a new command, the system can prompt the user to specify whether he/she would like to map the new command with a set of actions. When the user agrees to map the new command, the system can begin recording the actions/operations the user performs when performing the new command until a “done” action is performed. With this breadcrumb approach, the system creates a mapping of the new command and a set of actions/operations. The system can then record/save the mapping in a database.

The retail process automation system can learn one or more features associated with the received instructions, such as time of day of action, user information, location information, till numbers used, starting amounts, report types, and so on. For example, the system can learn that a store representative A opens a store with specific till numbers and specific starting amounts. The system records the action taken by a user A or preferences which is common for the store based on command. There can be phrase commands like “open store busy today”, “open store for event”, or “open store for thanksgiving” which identify to open a particular number of tills (e.g., greater than four tills, greater than six tills, and so on). Based on the learning and preference set by a user, the system can update the set of operations associated with the command. For example, when the system identifies that the received instructions are to open a store from store representative A, it can automatically suggest opening the store with the information it has learned. As another example, based on a pattern and phrase which it learns in store and day of action taken, the system can automatically suggest opening multiple tills or standard preference.

A “model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include, without limitation: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, models trained by the system can include a neural network with multiple input nodes that receive training datasets. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer,”) one or more nodes can produce a value classifying the input that, once the model is trained, can be used to assess likelihood that a caller is a scam caller, and so forth. In some implementations, such neural networks, known as deep neural networks, can have multiple layers of intermediate nodes with different configurations, can be a combination of models that receive different parts of the input and/or input from other parts of the deep neural network, or are convolutions-partially using output from previous iterations of applying the model as further input to produce results for the current input.

A machine learning model can be trained with supervised learning. Testing data can then be provided to the model to assess for accuracy. Testing data can be, for example, a portion of the training data (e.g., 10%) held back to use for evaluation of the model. Output from the model can be compared to the desired and/or expected output for the training data and, based on the comparison, the model can be modified, such as by changing weights between nodes of the neural network and/or parameters of the functions used at each node in the neural network (e.g., applying a loss function). Based on the results of the model evaluation, and after applying the described modifications, the model can then be retrained to evaluate new call data.

Returning to FIG. 3, after generating the suggested modifications, at act 320, process 300 presents one or more of the suggested modifications to a user. In some implementations, process 200 filters the generated suggested modifications to present a selected set. For example, process 200 can filter the generated suggestions based on user preference information, time of day, store information, and so on. For example, a user may have not noticed that a particular day is a holiday. But based on the behavior learnings, the system can recognize that the particular day is expected to be a busy day at the store. In this example, when a user just issues a command as “open store”, the system can suggest to the user that since the particular day is a holiday event, would the user like to open more tills than the usual preferences. At act 325, process 300 receives a final set of instructions and generates, at act 330, a set of operations for the final instructions set (similar to act 220 of FIG. 2). At act 335, process 300 executes the operations in the generated set of operations to alter the current state of the identified store (similar to act 225 of FIG. 2).

### Computer System

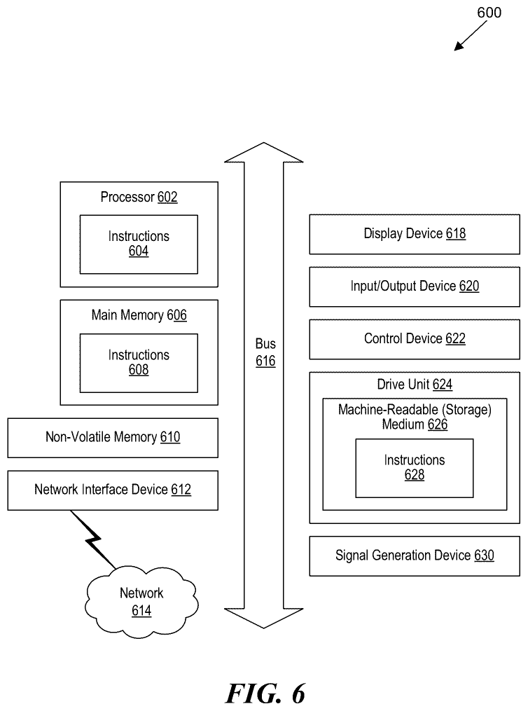

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementation, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### REMARKS

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or acts are presented in a given order, alternative implementations can perform routines having steps, or employ systems having acts, in a different order, and some processes or acts may be deleted, moved, added, subdivided, combined, and/or modified to provide alternative or sub-combinations. Each of these processes or acts can be implemented in a variety of different ways. Also, while processes or acts are at times shown as being performed in series, these processes or acts can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A computer system comprising:
at least one hardware processor; and
at least one non-transitory memory storing instructions, which, when executed by the at least one hardware processor, cause the computer system to:
receive an instruction for performing one or more operations on a plurality of retail stores;
apply a trained machine learning model to generate one or more suggested modifications to the received instruction;
generate one or more application programming interface (API) calls based on the generated one or more suggested modifications,
wherein the one or more operations comprise opening the plurality of retail stores, closing the plurality of retail stores, opening tills in the plurality of retail stores, closing the tills in the plurality of retail stores, performing an audit of the plurality of retail stores, and/or generating reports for the plurality of retail stores; and
perform, using the one or more API calls, the one or more operations on the plurality of retail stores.

2. The computer system of claim 1, wherein the machine learning model is trained using customer information, user information, store information, social media information, and/or news information.

3. The computer system of claim 1, wherein the plurality of retail stores are associated with a telecommunications service provider.

4. The computer system of claim 3, wherein a source of the instruction is affiliated with the telecommunications service provider.

5. The computer system of claim 1, wherein the instruction is received via a voice bot.

6. The computer system of claim 1, wherein the one or more operations are performed at an execution time determined based on operating hours of the plurality of retail stores and/or current events information.

7. The computer system of claim 1, wherein the received instruction comprises information identifying the plurality of retail stores.

8. A computer-implemented method comprising:
receiving an instruction for performing one or more operations on a plurality of retail stores;
generating one or more application programming interface (API) calls for the one or more operations,
wherein the one or more operations comprise opening the plurality of retail stores, closing the plurality of retail stores, opening tills in the plurality of retail stores, closing the tills in the plurality of retail stores, performing an audit of the plurality of retail stores, and/or generating reports for the plurality of retail stores; and
performing, using the one or more API calls, the one or more operations on the plurality of retail stores.

9. The computer-implemented method of claim 8, wherein the instruction is received via a voice bot.

10. The computer-implemented method of claim 8, comprising:
applying a trained machine learning model to generate one or more suggested modifications to the received instruction,
wherein the one or more API calls are generated based on the generated one or more suggested modifications.

11. The computer-implemented method of claim 10, wherein the machine learning model is trained using customer information, user information, store information, social media information, and/or news information.

12. The computer-implemented method of claim 8, wherein the one or more operations are performed at an execution time determined based on operating hours of the plurality of retail stores and/or current events information.

13. The computer-implemented method of claim 8, wherein the received instruction comprises information identifying the plurality of retail stores.

14. The computer-implemented method of claim 8, wherein a source of the instruction is affiliated with the telecommunications service provider.

15. At least one non-transitory computer-readable storage medium storing instructions, which, when executed by at least one data processor of a system, cause the system to:
receive an instruction for performing one or more operations on a plurality of retail stores;
generate one or more application programming interface (API) calls based on the received instruction,
wherein the one or more operations comprise opening the plurality of retail stores, closing the plurality of retail stores, opening tills in the plurality of retail stores, closing the tills in the plurality of retail stores, performing an audit of the plurality of retail stores, and/or generating reports for the plurality of retail stores; and
perform, using the one or more API calls, the one or more operations on the plurality of retail stores.

16. The non-transitory computer-readable storage medium of claim 15, wherein the plurality of retail stores are associated with a telecommunications service provider.

17. The non-transitory computer-readable storage medium of claim 15, wherein the instruction is received via a voice bot.

18. The non-transitory computer-readable storage medium of claim 15, wherein the instructions cause the system to:
apply a trained machine learning model to generate one or more suggested modifications to the received instruction,
wherein the one or more API calls are generated based on the generated one or more suggested modifications.

19. The non-transitory computer-readable storage medium of claim 18, wherein the machine learning model is trained using customer information, user information, store information, social media information, and/or news information.

20. The non-transitory computer-readable storage medium of claim 15, wherein the one or more operations are performed at an execution time determined based on operating hours of the plurality of retail stores and/or current events information.
